(19) United States
(12) Patent Application Publication
(10) Pub. No.: US 2011/0084179 A1
(43) Pub. Date: Apr. 14, 2011

(54) LINE FASTENING DEVICE

(75) Inventors: Christoph WIEDNER, Feldkirch (AT); Marc Nutzmann, Lindau (DE); Hermann Fritz, Landsberg (DE)

(73) Assignee: Hilti Aktiengesellschaft, Schaan (LI)

(21) Appl. No.: 12/899,877

(22) Filed: Oct. 7, 2010

(30) Foreign Application Priority Data
Oct. 8, 2009 (DE) 10 2009 045 499.3

(51) Int. Cl. F16L 3/08

(52) U.S. Cl. 248/67.7

(57) ABSTRACT

A line fastening device for fastening a line on a rail body which has a mounting opening is disclosed. The device includes a bracket element that has two spaced-apart legs, each with two rear engagement sections for engaging behind opposing edges of the mounting opening, which are provided on a free end region of the corresponding leg, and with a tensioning device for bracing the line fastening device on the rail body. Each leg has a first leg part and a second leg part that is spaced apart from the first leg part by a gap. The gap extends partially along the leg starting from the free end region of the leg. The leg parts of the leg are spring elastic.

This application claims the priority of German Patent Document No. 10 2009 045 499.3, filed Oct. 8, 2009, the disclosure of which is expressly incorporated by reference herein.

### BACKGROUND AND SUMMARY OF THE INVENTION

The invention relates to a line fastening device for fastening a line on a rail body, which has at least one mounting opening.

These types of line fastening devices are provided in the realm of installation technology, for example, for heating, ventilation, hot water, fresh water or waste water installations, for lines such as, for example, pipes or conduits, which have to be fastened to the rail body. The rail body is a C-shaped mounting rail, for example, which has a mounting opening running along the entire longitudinal extension. The rail body is fastened, for example, directly to a component, such as to a ceiling or a wall, or is suspended from the component via, for example, rod-shaped suspension elements such as threaded rods. These line fastening devices are also known to the person skilled in the art as strut clamps.

A line fastening device for fastening a line to a rail body with at least one mounting opening, which has one bracket element having two legs that are spaced apart from each another as well as one tensioning device for bracing the line fastening device on the rail body, is known from U.S. Pat. No. 7,073,755 B2. Provided on the free end regions of the legs is a respective rear engagement section, which, when the line fastening device is in a braced state, engages behind the same edge of the mounting opening.

The disadvantage of this known solution is that, because of the forces acting on the fastened line and the fact that fixing is only along one edge of the mounting opening, the line fastening device is also able to tilt in a braced state. In addition, such a line fastening device has a tendency to loosen from the edge of the mounting opening after being arranged on the rail body, for example, in the case of screw tensioning that is too low or during pre-assembly, which increases the complexity of mounting.

A line fastening device is known from U.S. Pat. No. 4,429,440, in which a rear engagement section is respectively provided on the free end regions of the two legs of the bracket element, and the rear engagement section is arranged in a diagonally offset manner for engaging behind the opposing edges of the mounting opening when the line fastening device is in a braced state.

The disadvantage of this known solution is that the line fastening device engages behind the edges of the mounting opening only at two points and because of the forces acting on the fastened line is also still able to tilt in a braced state. In addition, such a line fastening device has a tendency to loosen from the edge of the mounting opening after being arranged on the rail body, for example, in the case of screw tensioning that is too low or during pre-assembly, which increases the complexity of mounting.

A line fastening device is known from U.S. Pat. No. 5,163,644 that has a two-piece bracket element, wherein two rear engagement sections for engaging behind opposing edges of the mounting opening are respectively provided on the free end regions of the two legs of the bracket element.

The disadvantage of this known solution is that the line fastening device includes several parts that must be manipulated separately and the required loosening as well as pivoting of the parts and bracing of the line fastening device are laborious.

A line fastening device for fastening a line on a rail body is known from German Patent Document No. DE 1 674 009 U, which has at least one mounting opening, with a bracket element, which has two spaced-apart legs, each with two rear engagement sections for engaging behind opposing edges of the at least one mounting opening in the rail body, which rear engagement sections are provided on a free end region of the corresponding leg, and with a tensioning device for bracing the line fastening device on the rail body. The rear engagement sections are configured such that the line fastening device can be pivoted in the mounting opening.

The disadvantage of this known solution is that, to mount the line fastening device, a sufficiently large clearance is required around the rail body and, in addition, a sufficiently large undercut must be provided in the case of the rear engagement sections, which requires a correspondingly large relative displacement of the bracket element to the rail body for a secure fastening of the line fastening device and the to-be-fastened line when bracing the line fastening device.

The object of the invention is creating a line fastening device for fastening a line on a rail body that has at least one mounting opening, which does not have the aforementioned disadvantages and in particular enables simple mounting while guaranteeing secure fastening of the line fastening device.

According to the invention, each leg has a first leg part and a second leg part that is spaced apart from the first leg part by a gap, wherein the gap extends at least partially along the leg starting from the free end of the leg, and wherein at least one leg part is spring elastic.

When inserting the free end of the leg into the mounting opening of the rail body, at least the spring elastic leg part is pressed back in the direction of the other leg part and after reaching the pre-assembled position, in which the corresponding rear engagement section is behind or under the edge, it automatically transfers into the position engaging behind the corresponding edge through the advantageous spring force caused by the material of the bracket element. After bracing via the tensioning device, the line fastening device and the to-be-fastened line are advantageously simultaneously fixed on the rail body.

The gap is preferably configured as a slot, which is open on the free end of the corresponding leg. Alternatively, the gap is a circumferentially closed recess in the corresponding leg, which extends at least partially along the leg adjacent to the free end of the leg beginning in its end region. Due to the design of the gap, for example, with regard to its cross-section and its length, the at least one elastic leg part of a leg can be adapted according to the desired properties, e.g., the degree of spring elasticity.

The rear engagement sections of a leg are advantageously respectively aligned in such a way that, when the line fastening device is in a braced state, they run transverse to the longitudinal extension of the at least one mounting opening or of the rail body. As a result, a secure engagement behind the edges of the at least one mounting opening is guaranteed.

The line fastening device is advantageously inserted into the mounting opening perpendicular to a plane spanned by the mounting opening, wherein, in the case of a design of the bracket element with an essentially rigid leg part, the entire line fastening device is displaced laterally against the spring force of the spring elastic leg part.

Alternatively, the rigid leg part is clipped on an edge of the mounting opening and the line fastening device is pivoted in the direction of the rail body, wherein the spring elastic leg part is pressed back and then advantageously snaps into engagement behind the opposing edge of the mounting opening. In the case of this embodiment, a substantially smaller path and therefore a smaller clearance around the rail body are required for pivoting the line fastening device than is given, for example, in the case of a line fastening device according to German Patent Document No. DE 1 674 009 U.

Both leg parts of a leg are preferably spring elastic, whereby, when inserting the free ends of the legs into the mounting opening of the rail body, its leg parts are advantageously pressed together toward one another uniformly in one direction. As a result, a simple mounting of the line fastening device perpendicular to the plane spanned by the mounting opening is rendered possible.

An insertion section is preferably provided at least on one of the rear engagement sections of each leg, thereby further simplifying the insertion of the bracket element into the mounting opening. The insertion section is formed, for example, by a chamfer or bevel provided on the free end of the corresponding leg part. The insertion section is advantageously provided at least on the spring elastic leg part of the leg. All rear engagement sections especially advantageously have a respective insertion section provided on the free end.

At least the spring elastic leg part advantageously spans a plane, which is aligned transverse to the plane spanned by the other leg part, thereby guaranteeing a simple deflection of the spring elastic leg part. The plane spanned by the spring elastic leg part advantageously extends essentially parallel to the longitudinal extension of the mounting opening or of the rail body. Also advantageously, the plane spanned by the other leg part extends essentially perpendicular to the plane spanned by the spring elastic leg part and especially advantageously transverse and also advantageously perpendicular to the longitudinal extension of the mounting opening or of the rail body. In particular when the one leg part is configured to be rigid in comparison to the spring elastic leg part, a previously presented embodiment of the line fastening device is advantageous, because it can be inserted easily into the mounting opening of the rail body.

At least the spring elastic leg part of a leg advantageously has a leg section twisted by an angle of twist, wherein the corresponding rear engagement section is provided on the free end region of this leg section. Such a leg part is simple to deflect when inserting the legs of the bracket element. The angle of twist is advantageously 80° to 100° C., in particular 90°.

Both leg parts each preferably have a leg section twisted by an angle of twist, thereby guaranteeing a simple deflection of the two spring elastic leg parts. The twisted leg sections are preferably twisted in the opposite direction of each other, thereby guaranteeing simple manufacturing of the bracket element and therefore of the line fastening device.

In one alternative, at least one of the leg parts has a first leg section twisted by an angle of twist and a second leg section twisted by another angle of twist. The two twists are advantageously in the opposite direction on the at least one leg part. As a result, a simple deflection of the corresponding leg part is guaranteed during insertion of the leg of the bracket element into the mounting opening of the rail body. In the case of a bracket element made of a piece of bent sheet metal, because of the double twist of the corresponding leg part, the rear engagement sections can also be configured by stamping so that it can be subjected to higher loads as compared to a rear engagement section that is formed by a bending on the bracket element.

The bracket element is preferably one piece, which makes simple manufacturing of the same possible, for example, of sheet metal, for example, in a stamping/bending process.

At least one leg part of a leg is preferably formed by a wire section, which has a correspondingly configured bending on its end as a rear engagement section. The at least one wire section makes the configuration of a leg with advantageous spring characteristics possible along with simple manufacturing of the corresponding bracket element.

Both leg parts of a leg are preferably formed respectively by a wire section, wherein the distance between these wire sections forms the gap of the leg. This type of bracket element is simple to manufacture and flexible, for example, useable with respect to different rail bodies with mounting openings of different widths.

The invention is explained in greater detail in the following on the basis of exemplary embodiments.

### BRIEF DESCRIPTION OF THE DRAWINGS

FIG. 1 is a perspective view of a line fastening device fastened on a rail body;

FIG. 2 is a perspective view of a second exemplary embodiment of a line fastening device;

FIG. 3 is a perspective view of a third exemplary embodiment of a line fastening device; and

FIG. 4 is a perspective view of a fourth exemplary embodiment of a line fastening device.

### DETAILED DESCRIPTION OF THE DRAWINGS

As a rule, the same parts are provided with the same reference numbers in the figures.

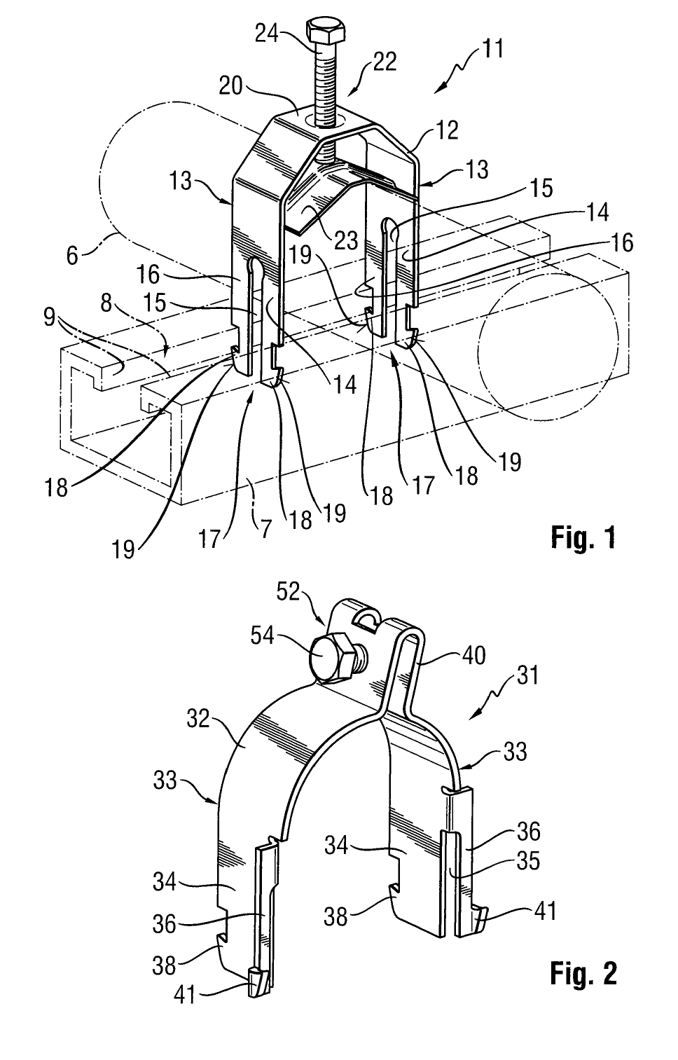

FIG. 1 shows a line fastening device 11 for fastening a line 6 on a rail body 7, which has a C-shaped cross-section and a mounting opening 8 extending along the longitudinal extension of the rail body 7. The mounting opening 8 is bordered by two opposing edges 9.

The line fastening device 11 has a U-shaped bracket element 12 and a tensioning device 22 for bracing the line fastening device 11 and simultaneously fastening the line 6 on the rail body 7. The tensioning device 22 includes a clamping plate 23 that can be abutted with an outer side of the line 6, and is displaceable relative to bracket element 12 via a screw mounted in the bracket element 12 as a tensioning means 24.

The bracket element 12 that is configured as one piece has two spaced-apart legs 13, each of which has a first leg part 14 and a second leg part 16 that is spaced apart from the first leg part 14 by a gap 15. The gap 15 is a slot that is open on one side and extends partially along the leg starting from the free end of the leg 13. Both leg parts 14 and 16 of a leg 13 are spring elastic.

The legs 13 are connected with each other via a connecting section 20, in which the tensioning means 24 of the tensioning device 22 is positioned.

A respective rear engagement section 18 is provided on a free end region 17 of each leg 13 and therefore on the free end region of the first leg part 14 and of the second leg part 16 for engaging behind the opposing edges 9 of the mounting opening 8 in the rail body 7. Each of these rear engagement sections 18 respectively has an insertion section 19 in the form of a chamfer or a bevel.

To fasten the to-be-fastened line 6 on the rail body 7, the line is disposed on the rail body 7 and then the line fastening device 11 is inserted perpendicularly into the mounting opening 8. In the process, the two spring elastic leg sections 14 and 16 of a leg 13 are respectively pressed together as soon as the insertion sections 19 on the rear engagement sections 18 are adjacent with the outer side of the edges 9 and the line fastening device 11 is again inserted into the mounting opening 8. As soon as the rear engagement sections 18 have penetrated sufficiently deeply into the rail body 7, the leg sections 14 and 16 are forced into a position of engagement behind the edges 9 as result of the restoring force acting on the leg sections. By actuating the tensioning means 24, the line 6 is pressed relative to the rail body 7 and at the same time the bracket element 12 is displaced relative to the rail body 7 away from the same, until the line fastening device 11 and the line 6 are adequately braced on the rail body 7.

The line fastening device 31 depicted in FIG. 2 has a one-piece bracket element 32, wherein the legs 33 each have a comparatively rigid first leg part 34 with a first rear engagement section 38 and a spring elastic second leg part 36 that is spaced apart from the first leg part by the gap 35 and that has a second rear engagement section 41. The spring elastic second leg part 36 spans a plane that is aligned transverse to the plane spanned by the first leg part 34. The first rear engagement section 38 lies in the plane spanned by the first leg part 34, wherein the second rear engagement section 41 advantageously projects perpendicularly from the plane spanned by the second leg part 36.

The bracket element 32 also has a bent-out portion 40 projecting outwardly with spaced-apart wall sections, which has a feed-through opening for a tension screw as tensioning means 54, which forms a portion of the tensioning device 52.

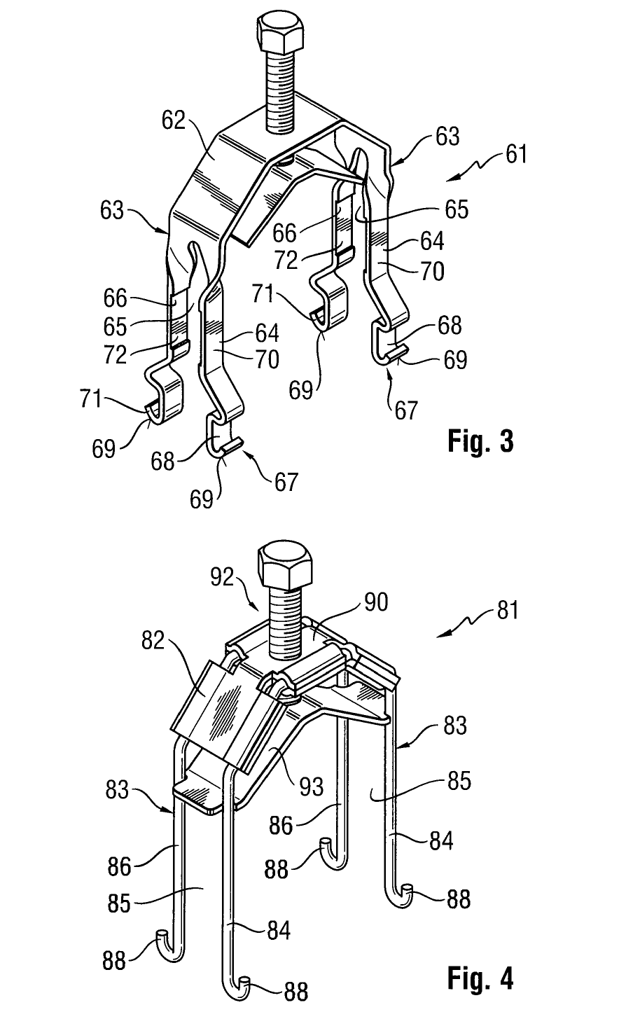

The line fastening device 61 depicted in FIG. 3 differs from the previously presented line fastening device 11 through the embodiment of the legs 63 of the bracket element 62. Each leg 63 has a first spring elastic leg part 64, which has a leg section 70 that is twisted by an angle of twist of 90°. The corresponding rear engagement section 68 is provided on the free end region 67 of this leg section 70. Each leg 63 also has a second spring elastic leg part 66, which is spaced apart from the first leg part 64 by the gap 65 and that has a leg section 72 twisted by an angle of twist of 90°. The corresponding rear engagement section 71 is provided on the free end region of this leg section 72. The rear engagement sections 68 and 71 are formed by a bending provided on the corresponding leg part 64 or 66 so that its bottom side respectively forms an insertion section 69. The leg sections 70 are twisted in the opposite direction from the leg sections 72.

In the case of the line fastening device 81 depicted in FIG. 4, the legs 83 of the bracket element 82 are formed by two wire sections, which are connected to each other via a connecting section 90 of the bracket element 82. The two wire sections 83 respectively form the first leg section 84 and the second leg section 86 that is spaced-apart therefrom. Respectively provided on the free ends of the leg sections 84 and 86 are outwardly projecting bendings, which form the rear engagement sections 88 for engaging behind the edges 9 of the mounting opening 8 of the rail body 7. The gap 85 between the wire sections 83 furthermore forms a guide for the clamping plate 93 of the tensioning device 92.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A line fastening device, comprising:
a bracket element that has two spaced-apart legs, wherein each leg has two rear engagement sections that are provided on a free end region of the leg; and
a tensioning device coupled to the bracket element;
wherein each leg has a first leg part and a second leg part that is spaced apart from the first leg part by a gap, wherein the gap extends at least partially along the leg starting from the free end region of the leg, and wherein at least one of the two leg parts is spring elastic.

2. The line fastening device according to claim 1, wherein both of the two leg parts are spring elastic.

3. The line fastening device according to claim 1, wherein an insertion section is provided on at least one of the two rear engagement sections of each leg.

4. The line fastening device according to claim 1, wherein the at least one of the two leg parts that is spring elastic spans a plane that is aligned transverse to a plane spanned by the other of the two leg parts.

5. The line fastening device according to claim 1, wherein the at least one of the two leg parts that is spring elastic has a leg section twisted by an angle of twist.

6. The line fastening device according to claim 5, wherein both leg parts each have a leg section twisted by an angle of twist, wherein the twisted leg sections are twisted in an opposite direction of each other.

7. The line fastening device according to claim 1, wherein the bracket element is one piece.

8. The line fastening device according to claim 1, wherein at least one leg part of a leg is formed by a wire section.

9. The line fastening device according to claim 8, wherein both leg parts of a leg are respectively formed by a wire section.
